(19) United States
(12) Patent Application Publication
(10) Pub. No.: US 2026/0169678 A1
(43) Pub. Date: Jun. 18, 2026

(54) APPLYING STEM REBALANCING AND METADATA FOR HOME THEATER SYSTEM

(71) Applicants: Sony Group Corporation, Tokyo (JP); Sony Pictures Entertainment Inc., Culver City, CA (US)

(72) Inventor: Justin Arnold Herman, Los Angeles, CA (US)

(21) Appl. No.: 19/190,358

(22) Filed: Apr. 25, 2025

(51) Int. Cl. G06F 3/16

(52) U.S. Cl. CPC G06F 3/165

(57) ABSTRACT

Generating metadata and stem rebalancing of content using the generated metadata, including: mixing individual stems of the content including dialog, music, and effects; playing back the content at a selected plurality of volumes to adjust a trim or audio level for each stem so that the creative intent is reflected at each volume of the selected plurality of volumes; saving trims of the individual stems for each volume as the metadata; and transmitting the individual stems and the metadata to enable playback of the content with creative intent.

### BACKGROUND

### Field

The present disclosure relates to home theater systems, and more specifically to real-time application of stem rebalancing and metadata based on a given volume selected by a consumer on the home theater system.

### Background

The home consumers can play back content at any given volume. As volume changes so does the apparent relationship between dialog, music, and effects. However, as volume changes, how frequencies and mixtures of the dialog, music, and effects are perceived to the human ear changes, which may cause intelligibility issues and may deviate from the creative intent on what should be heard at any given time during the content playback.

### SUMMARY

The present disclosure provides for stem rebalancing of content being played back on a home theater system using metadata.

In one implementation, a method for generating metadata and stem rebalancing of content using the generated metadata is disclosed. The method includes: mixing individual stems of the content including dialog, music, and effects; playing back the content at a selected plurality of volumes to adjust a trim or audio level for each stem so that the creative intent is reflected at each volume of the selected plurality of volumes; saving trims of the individual stems for each volume as the metadata; and transmitting the individual stems and the metadata to enable playback of the content with creative intent.

In another implementation, a non-transitory computer-readable storage medium storing a computer program to generate metadata and to stem rebalance content using the generated metadata is disclosed. The computer program includes executable instructions that cause a computer to: mix individual stems of the content including dialog, music, and effects; play back the content at a selected plurality of volumes to adjust a trim or audio level for each stem so that the creative intent is reflected at each volume of the selected plurality of volumes; save trims of the individual stems for each volume as the metadata; and transmit the individual stems and the metadata to enable playback of the content with creative intent.

Other features and advantages should be apparent from the present description which illustrates, by way of example, aspects of the disclosure.

### BRIEF DESCRIPTION OF THE DRAWINGS

The details of the present disclosure, both as to its structure and operation, may be gleaned in part by study of the appended drawings, in which like reference numerals refer to like parts, and in which:

FIG. 1 is a block diagram illustrating a home theater system in accordance with one implementation of the present disclosure;

FIG. 2 is a flow diagram illustrating a method for stem rebalancing and frequency curve application of content in accordance with one implementation of the present disclosure;

FIG. 3 is a flow diagram of a method for implementing the creation part in accordance with once implementation of the present disclosure; and

FIG. 4 is a flow diagram of a method for implementing the playback part in accordance with once implementation of the present disclosure.

### DETAILED DESCRIPTION

As described above, in a conventional home theater system, as volume changes, how frequencies and mixture of dialog, music, and effects are perceived by the human ear changes. Accordingly, the changes in the perception may cause intelligibility issues and may deviate from the creative intent on what should be heard at any given time during the content playback.

Application of stem rebalancing and frequency curve may be used in music production to separate the mix of a song into individual stems (e.g., dialog, music, and effects) and to adjust the volume of each stem independently. In one implementation, the application allows for remixing or re-balancing of the mix. For example, if a mix sounds unbalanced (e.g., dialogs are too quiet or effects are too loud), stem rebalancing may be used to adjust the levels of the individual stems. In another implementation, the application allows for changing the profile of how frequencies (i.e., a system wide frequency curve or frequency response) are played back based on the loudness of the system.

Certain implementations of the present disclosure provide for apparatus and methods to implement a technique for applying real-time stem rebalancing and frequency curve based on a given volume selected by a consumer on an audio system. Thus, the real-time stem rebalancing and applying frequency curve technique enables the consumer to hear or perceive the content as if the content had been mixed with a creative intent of a content creator at the given volume.

In one implementation, a processor coupled to the audio system (e.g., audio/video receiver (AVR), sound bar, or television) monitors the volume change made at the audio system and determines the perceived loudness. In one implementation, as the consumer changes the volume, the processor rebalances the stems real-time by applying an appropriate equalization necessary to counter the effects of the changing perceived loudness. In another implementation, as the consumer changes the volume, the processor changes the profile of how frequencies (i.e., a system wide frequency curve or frequency response) are played back based on the perceived loudness. In a further implementation, the processor further rebalances the stems real-time in accordance with metadata provided by the content creator that reflects the creative intent at the given volume.

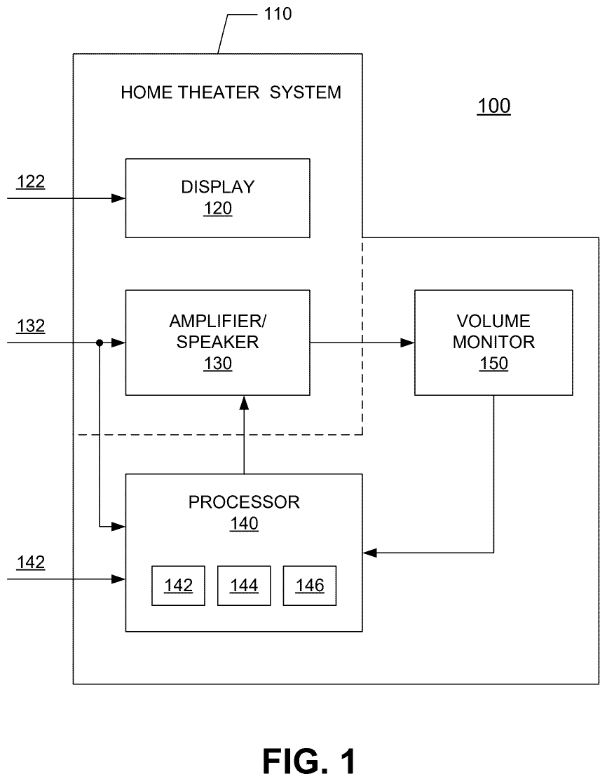

FIG. 1 is a block diagram 100 illustrating a home theater system 110 in accordance with one implementation of the present disclosure. In the illustrated implementation of FIG. 1, the home theater system 110 includes at least a display 120 and an amplifier/speaker 130. In one implementation, the home theater system 110 also includes a processor 140 and a volume monitor 150. In another implementation, the processor 140 and the volume monitor 150 are configured as separate from but coupled to the home theater system 110. In one implementation, the home theater system 110 receives an audio/video input 122, 132, directs the video input 122 to the display 120, and directs the audio input 132 to the amplifier/speaker 130 and the processor 140. In one implementation, audio out of the amplifier/speaker 130 is then captured by the volume monitor 150.

In one implementation, the home theater system 110 includes knowledge of the volume of the audio output of the content by capturing the output of individual channels or streaming applications of the content. To this end, the home theater system 110 needs to sense the voltage coming out of the amplifiers, correlate the voltage with frequencies that match the typical dialog with the audio output of the content, and measure the sound pressure level (SPL) using a microphone coupled to the audio output device (e.g., amplifier/speaker). That is, the system needs to measure how loud the content is perceived regardless of how loud any individual application, stream, or channel correlates the volume to the real world.

In one implementation, the volume monitor 150 is used to sense the volume or loudness (i.e., the perceived volume) at the output of the amplifier/speaker 130, and the processor 140 then receives and normalizes the sensed volume across different signals, services, and programs. In one implementation, the volume monitor 150 includes a microphone.

In one implementation, the processor 140 receives the sensed volume (i.e., perceived loudness) and implements an equalization curve that changes with the sensed volume so that the perceived frequencies stay flat as the absolute volume changes. That is, as the consumer changes the volume on the home theater system 110, the processor 140 applies the equalization (i.e., the stem rebalancing) necessary to counter the effects of the changing perceived frequencies so that the consumer perceives a constant loudness. In one implementation, the equalization includes boosting low and high frequency components of the audio input to offset loudness fall off to prevent the sensed volume from being dominated by the mid frequencies. In one implementation, the processor 140 includes a rebalancing unit 142 to rebalance the individual stems real-time by applying an appropriate equalization necessary to counter effects of changing perceived frequencies. In another implementation, the processor 140 includes a stem adjuster 144 to adjust a volume of each stem independently using the equalization curve.

In another implementation, the processor 140 includes a frequency curve adjuster 146 which receives the sensed volume (i.e., perceived loudness) and implements changing of the profile of how frequencies (i.e., a system wide frequency curve or frequency response) are played back based on the loudness of the system.

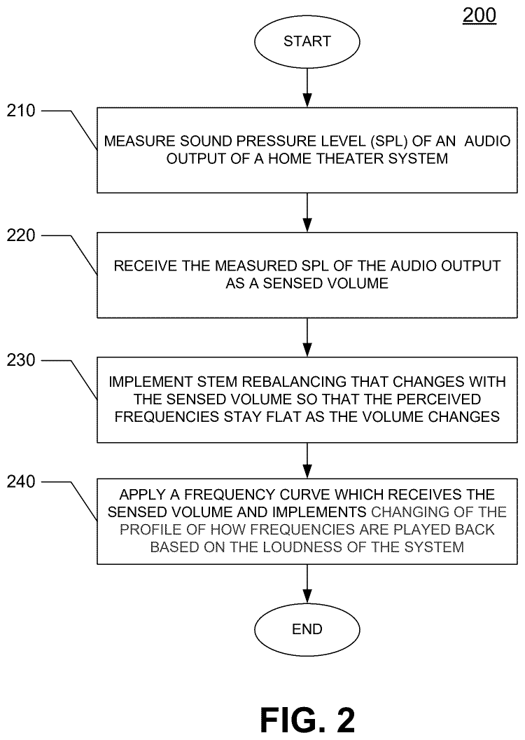

FIG. 2 is a flow diagram illustrating a method 200 for stem rebalancing and frequency curve application of content in accordance with one implementation of the present disclosure. In the illustrated implementation of FIG. 2, the sound pressure level (SPL) of an audio output of the content is measured, at step 210. In one implementation, the SPL is measured using a microphone coupled to the audio output device (e.g., amplifier/speaker 130) to determine how loud the content is perceived regardless of how loud any individual application, stream, or channel correlates the volume to the real world. In one implementation, the content includes a mix of individual stems (e.g., dialog, music, and effects). The measured SPL of the audio output is received, at step 220, as a sensed or perceived volume. In one implementation, the volume monitor 150 is used to sense the volume at the output of the amplifier/speaker 130.

In one implementation, stem rebalancing which changes with the sensed volume is then implemented, at step 230, so that the perceived frequencies stay flat as the volume changes. In one implementation, as the consumer changes the volume, the processor 140 rebalances the stems real-time by applying an appropriate equalization necessary to counter the effects of the changing perceived frequencies and mix. Thus, in one implementation, implementing the stem rebalancing includes adjusting the volume of each stem independently using the equalization curve.

In another implementation, a frequency curve application which receives the sensed volume and implements changing of the profile of how frequencies are played back based on the loudness of the system is implemented, at step 240. The application of the frequency curve enables the perceived frequencies to stay flat as the volume changes. Thus, as the consumer changes the volume, the profile of how frequencies are played back is changed based on the loudness of the system.

It was disclosed above that the mixing studio may provide dynamic metadata (i.e., the metadata implementation) for how the stems balance at different listening levels throughout the content. The metadata implementation includes two parts: a creation part and a playback part.

In the creation part, the audio input 132 includes a final mix separated by dialog, music, and effects provided by a mixing studio. In one implementation, the mixing studio adhering to the creative intent balances the stems at a plurality of different listening levels. In one example, the stems are balanced at a loud listening level (e.g., at approximately 85 dB SPL) and a low listening level (e.g., at approximately 60-65 dB SPL). In another implementation, the mixing studio provides dynamic metadata for how the stems balance at different listening levels throughout the content. The stems and metadata 142 are then delivered to the processor 140.

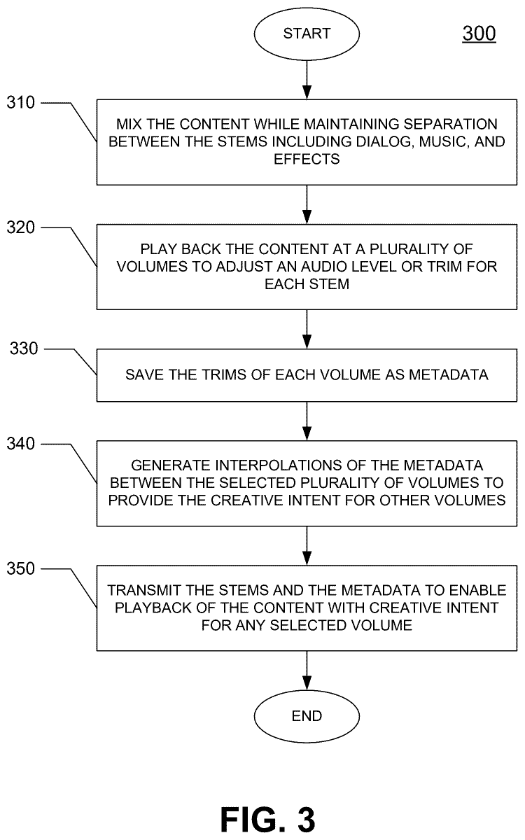

FIG. 3 is a flow diagram of a method 300 for implementing the creation part in accordance with once implementation of the present disclosure. In the illustrated implementation of FIG. 3, the content is initially mixed, at step 310, while maintaining separation between the stems including dialog, music, and effects. The content is then played back at a plurality of volumes, at step 320, to adjust an audio level (i.e., a trim) for each stem so that the creative intent is reflected at each volume of the plurality of volumes. In one implementation, the plurality of volumes is selected to encompass substantial portions of the possible playback volumes. The plurality of volumes may include at least a highest volume at approximately 85 dB (i.e., 85+8.5 dB) SPL and a lowest volume at approximately 60-65 dB (i.e., 60-65+6.5 dB) SPL. The plurality of volumes may include other volumes between loudest and lowest volumes. The trims are then saved, at step 330, as metadata.

In the illustrated implementation of FIG. 3, interpolations of the metadata are generated, at step 340, between the selected plurality of volumes to provide the creative intent for other volumes between the selected plurality of volumes. The stems and the metadata are then transmitted to the home theater system, at step 350, to enable playback of the content with creative intent for any selected volume.

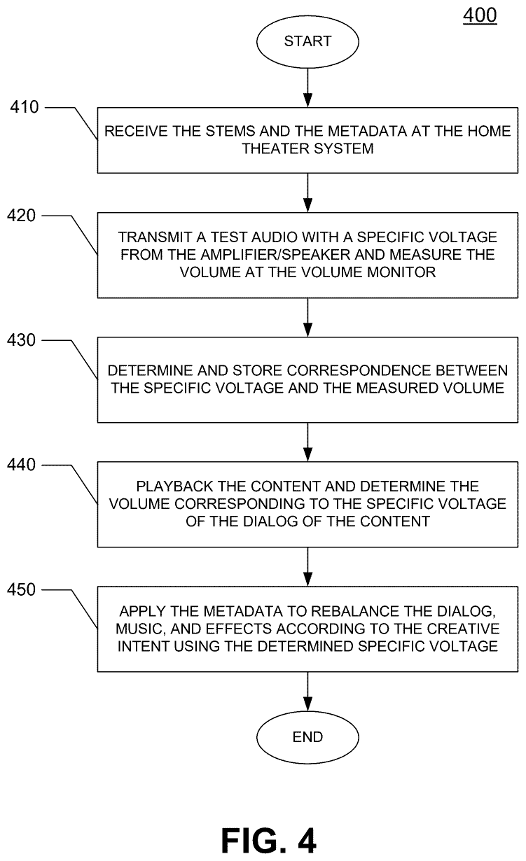

FIG. 4 is a flow diagram of a method 400 for implementing the playback part in accordance with once implementation of the present disclosure. In the illustrated implementation of FIG. 4, the stems and the metadata are received, at step 410, at the home theater system. At step 420, a test audio with a specific voltage is transmitted from the amplifier/speaker 130 and a first volume (i.e., SPL) is measured at the volume monitor 150. In one implementation, the specific volage of the test audio is measured at the output of the amplifier. At step 430, a correspondence between the specific voltage and the first volume is determined and stored. At step 440, the content is played back and a second volume corresponding to the specific voltage of the dialog of the content is determined. The metadata is then applied, at step 450, using the second volume to rebalance the dialog, music, and effects according to the creative intent.

In a particular implementation, a method for generating metadata and stem rebalancing of content using the generated metadata is disclosed. The method includes: mixing individual stems of the content including dialog, music, and effects; playing back the content at a selected plurality of volumes to adjust a trim or audio level for each stem so that the creative intent is reflected at each volume of the selected plurality of volumes; saving trims of the individual stems for each volume as the metadata; and transmitting the individual stems and the metadata to enable playback of the content with creative intent.

In one implementation, the method further includes generating interpolations of the metadata between the selected plurality of volumes to provide the creative intent for other volumes between the selected plurality of volumes. In one implementation, the selected plurality of volumes encompasses substantial portions of possible playback volumes. In one implementation, the selected plurality of volumes includes a first volume at approximately 85 dB SPL and a second volume at approximately 60-65 dB SPL. In one implementation, the selected plurality of volumes includes other volumes between the first and second volumes. In one implementation, the method further includes: receiving the individual stems and the metadata; transmitting a test audio with a specific voltage and measuring a first volume; determining and storing a correspondence between the specific voltage and the first volume; and playing back the content and determining a second volume corresponding to the specific voltage of the dialog of the content. In one implementation, the method further includes applying the metadata using the second volume to rebalance the individual stems according to the creative intent.

In another particular implementation, a non-transitory computer-readable storage medium storing a computer program to generate metadata and to stem rebalance content using the generated metadata is disclosed. The computer program includes executable instructions that cause a computer to: mix individual stems of the content including dialog, music, and effects; play back the content at a selected plurality of volumes to adjust a trim or audio level for each stem so that the creative intent is reflected at each volume of the selected plurality of volumes; save trims of the individual stems for each volume as the metadata; and transmit the individual stems and the metadata to enable playback of the content with creative intent.

In one implementation, the non-transitory computer-readable storage medium further includes executable instructions that cause the computer to generate interpolations of the metadata between the selected plurality of volumes to provide the creative intent for other volumes between the selected plurality of volumes. In one implementation, the selected plurality of volumes encompasses substantial portions of possible playback volumes. In one implementation, the selected plurality of volumes includes a first volume at approximately 85 dB SPL and a second volume at approximately 60-65 dB SPL. In one implementation, the selected plurality of volumes includes other volumes between the first and second volumes. In one implementation, the non-transitory computer-readable storage medium further includes executable instructions that cause the computer to: receive the individual stems and the metadata; transmit a test audio with a specific voltage and measuring a first volume; determine and store a correspondence between the specific voltage and the first volume; and play back the content and determine a second volume corresponding to the specific voltage of the dialog of the content. In one implementation, the non-transitory computer-readable storage medium further includes executable instructions that cause the computer to apply the metadata using the second volume to rebalance the individual stems according to the creative intent.

After reading below descriptions, it will become apparent how to implement the disclosure in various implementations and applications. Although various implementations of the present disclosure will be described herein, it is understood that these implementations are presented by way of example only, and not limitation. As such, the detailed description of various implementations should not be construed to limit the scope or breadth of the present disclosure.

The description herein of the disclosed implementations is provided to enable any person skilled in the art to make or use the present disclosure. Numerous modifications to these implementations would be readily apparent to those skilled in the art, and the principals defined herein can be applied to other implementations without departing from the spirit or scope of the present disclosure. Thus, the present disclosure is not intended to be limited to the implementations shown herein but is to be accorded the widest scope consistent with the principal and novel features disclosed herein.

Various implementations of the present disclosure are realized in electronic hardware, computer software, or combinations of these technologies. Some implementations include one or more computer programs executed by one or more computing devices. In general, the computing device includes one or more processors, one or more data-storage components (e.g., volatile or non-volatile memory modules and persistent optical and magnetic storage devices, such as hard and floppy disk drives, CD-ROM drives, and magnetic tape drives), one or more input devices (e.g., game controllers, mice and keyboards), and one or more output devices (e.g., display devices).

The computer programs include executable code that is usually stored in a persistent storage medium and then copied into memory at run-time. At least one processor executes the code by retrieving program instructions from memory in a prescribed order. When executing the program code, the computer receives data from the input and/or storage devices, performs operations on the data, and then delivers the resulting data to the output and/or storage devices.

Those of skill in the art will appreciate that the various illustrative modules and method steps described herein can be implemented as electronic hardware, software, firmware or combinations of the foregoing. To clearly illustrate this interchangeability of hardware and software, various illustrative modules and method steps have been described herein generally in terms of their functionality. Whether such functionality is implemented as hardware or software depends upon the application and design constraints imposed on the overall system. Skilled persons can implement the described functionality in varying ways for each application, but such implementation decisions should not be interpreted as causing a departure from the scope of the present disclosure. In addition, the grouping of functions within a module or step is for ease of description. Specific functions can be moved from one module or step to another without departing from the present disclosure.

All features of each above-discussed example are not necessarily required in a particular implementation of the present disclosure. Further, it is to be understood that the description and drawings presented herein are representative of the subject matter that is broadly contemplated by the present disclosure. It is further understood that the scope of the present disclosure fully encompasses other implementations that may become obvious to those skilled in the art and that the scope of the present disclosure is accordingly limited by nothing other than the appended claims.

1. A method for generating metadata and stem rebalancing of content using the generated metadata, the method comprising:
mixing individual stems of the content including dialog, music, and effects;
playing back the content at a selected plurality of volumes to adjust a trim or audio level for each stem so that the creative intent is reflected at each volume of the selected plurality of volumes;
saving trims of the individual stems for each volume as the metadata; and
transmitting the individual stems and the metadata to enable playback of the content with creative intent.

2. The method of claim 1, further comprising
generating interpolations of the metadata between the selected plurality of volumes to provide the creative intent for other volumes between the selected plurality of volumes.

3. The method of claim 1, wherein the selected plurality of volumes encompasses substantial portions of possible playback volumes.

4. The method of claim 1, wherein the selected plurality of volumes includes a first volume at approximately 85 dB SPL and a second volume at approximately 60-65 dB SPL.

5. The method of claim 4, wherein the selected plurality of volumes includes other volumes between the first and second volumes.

6. The method of claim 1, further comprising:
receiving the individual stems and the metadata;
transmitting a test audio with a specific voltage and measuring a first volume;
determining and storing a correspondence between the specific voltage and the first volume; and
playing back the content and determining a second volume corresponding to the specific voltage of the dialog of the content.

7. The method of claim 6, further comprising
applying the metadata using the second volume to rebalance the individual stems according to the creative intent.

8. A non-transitory computer-readable storage medium storing a computer program to generate metadata and to stem rebalance content using the generated metadata, the computer program comprising executable instructions that cause a computer to:
mix individual stems of the content including dialog, music, and effects;
play back the content at a selected plurality of volumes to adjust a trim or audio level for each stem so that the creative intent is reflected at each volume of the selected plurality of volumes;
save trims of the individual stems for each volume as the metadata; and
transmit the individual stems and the metadata to enable playback of the content with creative intent.

9. The non-transitory computer-readable storage medium of claim 8, further comprising executable instructions that cause the computer to
generate interpolations of the metadata between the selected plurality of volumes to provide the creative intent for other volumes between the selected plurality of volumes.

10. The non-transitory computer-readable storage medium of claim 8, wherein the selected plurality of volumes encompasses substantial portions of possible playback volumes.

11. The non-transitory computer-readable storage medium of claim 8, wherein the selected plurality of volumes includes a first volume at approximately 85 dB SPL and a second volume at approximately 60-65 dB SPL.

12. The non-transitory computer-readable storage medium of claim 11, wherein the selected plurality of volumes includes other volumes between the first and second volumes.

13. The non-transitory computer-readable storage medium of claim 8, further comprising executable instructions that cause the computer to:
receive the individual stems and the metadata;
transmit a test audio with a specific voltage and measuring a first volume;
determine and store a correspondence between the specific voltage and the first volume; and
play back the content and determine a second volume corresponding to the specific voltage of the dialog of the content.

14. The non-transitory computer-readable storage medium of claim 13, further comprising executable instructions that cause the computer to
apply the metadata using the second volume to rebalance the individual stems according to the creative intent.
